(19) United States
(12) Patent Application Publication
(10) Pub. No.: US 2025/0123382 A1
(43) Pub. Date: Apr. 17, 2025

(54) ULTRASOUND IMAGING DEVICE WITH LOW POWER DATA TRANSMISSION FROM TRANSDUCER TO SYSTEM, AND METHODS OF TRANSMISSION

(71) Applicant: SAVORD TECHNOLOGIES LLC, ANDOVER, MA (US)

(72) Inventor: Bernard Savord, Andover, MA (US)

(21) Appl. No.: 18/897,407

(22) Filed: Sep. 26, 2024

Related U.S. Application Data
(60) Provisional application No. 63/589,694, filed on Oct. 12, 2023.

(51) Int. Cl. G01S 7/52; G01S 15/89

(52) U.S. Cl. CPC G01S 7/52096; G01S 15/8909

(57) ABSTRACT

In an ultrasound imaging device, an ultrasound imaging transducer produces digitized echo data in response to the transmission of acoustic energy. A base system processes the digitized echo data. A cable assembly communicates the digitized echo data between the transducer and the base system. An electronic cable driver at the imaging transducer is constructed and arranged to transmit the digitized echo data at a rate greater than about 1 Gbs from the transducer to the base system over the cable assembly at a reduced voltage. An amplifier at the base system amplifies received digitized echo data from the reduced voltage to an amplified voltage suitable for further processing at the base system. The reduced voltage is about 300 mV peak to peak or less.

### RELATED APPLICATIONS

This application claims the benefit of U.S. Provisional Patent Application Ser. No. 63/589,694, “AN ULTRASOUND IMAGING DEVICE WITH LOW POWER DATA TRANSMISSION FROM TRANSDUCER TO SYSTEM”, filed Oct. 12, 2023, the content of which is incorporated herein by reference in its entirety for all purposes.

### BACKGROUND

Digitizing ultrasound echoes within an ultrasound imaging transducer as described in patent applications US20210007717A1 and WO2023213748A1 lowers the cost of the imaging system since a front end is not needed within the system, increases the cable flexibility and reliability with fewer connections by streaming multiple channels in each connection and increases performance by allowing more digitized channels than the system otherwise would have. For maximum flexibility, it is desirable to stream data from each individual transducer element or sub-array of elements into the system for processing. The high data rates required result in significant power using state of the art communication methods. This large power consumption may make the transducer unacceptably warm.

Many applications such as catheter based and transesophageal are limited by the number of cable connections that can fit within the assembly. State of the art digital communication links run full duplex mode resulting in more connections than desired.

### SUMMARY

According to an aspect of the present disclosure, a low power communication method is disclosed for communication between the system and ultrasound imaging transducer with a reduced number of interconnects.

The power is reduced through the use of low voltage data transmission over the cable followed by amplification within the system.

The number of cable connections is reduced through the use of a half-duplex mode whereby a common connection is used for data transmission both to and from the transducer. Connections are optionally further reduced through the use of single ended transmission,

Another aspect of this disclosure is the use of direct current (DC) coupling to eliminate the need for coding that maintains a DC balance. Power is saved by eliminating the overhead of such a coding scheme.

In an aspect, an ultrasound imaging system comprises: an ultrasound imaging transducer that produces digitized echo data in response to the transmission of acoustic energy; a base system that processes the digitized echo data; a cable assembly that communicates the digitized echo data between the transducer and the base system; an electronic cable driver at the imaging transducer constructed and arranged to transmit the digitized echo data at a rate greater than about 1 Gbs from the transducer to the base system over the cable assembly at a reduced voltage; and an amplifier at the base system to amplify received digitized echo data from the reduced voltage to an amplified voltage suitable for further processing at the base system, wherein the reduced voltage is about 300 mV peak to peak or less.

In some embodiments, the reduced voltage is about 200 mV peak to peak or less.

In some embodiments, the reduced voltage is about 150 mV peak to peak or less.

In some embodiments, the cable assembly communicates the digitized echo data from the transducer to the base system in a first direction, the cable assembly communicates the configuration data from the base system to the transducer in a second direction, and the digitized echo data and configuration data are transmitted on a common channel of the cable assembly in a half-duplex configuration.

In some embodiments, the digitized echo data is communicated at the reduced peak-to-peak voltage, and wherein the configuration data is communicated at a second peak-to-peak voltage that is different than the reduced peak-to-peak voltage.

In some embodiments, the second peak-to-peak voltage is greater than the reduced peak-to-peak voltage.

In some embodiments, the digitized echo data and configuration data are transmitted on a common wire of the cable assembly.

In some embodiments, the digitized echo data is communicated from the transducer to the base system in a single-ended communication protocol.

In some embodiments, the digitized echo data is communicated from the transducer to the base system in a DC coupled communication protocol.

In another aspect, an ultrasound imaging comprises: an ultrasound imaging transducer that produces digitized echo data in response to configuration data; a base system that generates the configuration data and that processes the digitized echo data to form an image; and a cable assembly that communicates the configuration data from the base system to the transducer in a first direction and that communicates the digitized echo data from the transducer to the base system in a second direction, wherein the configuration data and the digitized echo data are transmitted on a common channel of the cable assembly in a half-duplex configuration.

In some embodiments, the device further comprises: an electronic cable driver at the imaging transducer constructed and arranged to transmit the digitized echo data at a rate greater than about 1 Gbs from the transducer to the base system in the first direction over the cable assembly at a reduced voltage; and an amplifier at the base system to amplify received digitized echo data from the reduced voltage to an amplified voltage suitable for further processing at the base system to form the image, wherein the reduced voltage is about 300 mV peak to peak or less.

In some embodiments, the reduced voltage is about 200 mV peak to peak or less.

In some embodiments, the reduced voltage is about 150 mV peak to peak or less.

In some embodiments, the digitized echo data is communicated at the reduced peak-to-peak voltage, and the configuration data is communicated at a second peak-to-peak voltage that is different than the reduced peak-to-peak voltage.

In some embodiments, the second peak-to-peak voltage is greater than the reduced peak-to-peak voltage.

In some embodiments, the digitized echo data and configuration data are transmitted on a common wire of the cable assembly.

In some embodiments, the digitized echo data is communicated from the transducer to the base system in a single-ended communication protocol.

In some embodiments, the digitized echo data is communicated from the transducer to the base system in a DC coupled communication protocol.

In another aspect, a method of streaming digitized echo data from an ultrasound imaging transducer to a base system comprises: generating digitized echo data at an ultrasound imaging transducer in response to the transmission of acoustic energy; receiving and processing the digitized echo data at a base system; communicating the digitized echo data between the transducer and the base system at a cable assembly; transmitting the digitized echo data at a rate greater than about 1 Gbs from the transducer to the base system over the cable assembly at a reduced voltage at an electronic cable driver at the imaging transducer; and amplifying, at an amplifier at the base system, the received digitized echo data from the reduced voltage to an amplified voltage suitable for further processing at the base system, wherein the reduced voltage is about 300 mV peak to peak or less.

In some embodiments, the reduced voltage is about 200 mV peak to peak or less.

In some embodiments, the reduced voltage is about 150 mV peak to peak or less.

In some embodiments, the method further comprises: communicating, at the cable assembly, the digitized echo data from the transducer to the base system in a first direction, communicating, at the cable assembly, the configuration data from the base system to the transducer in a second direction, and transmitting the digitized echo data and configuration data on a common channel of the cable assembly in a half-duplex configuration.

In some embodiments, the method further comprises: communicating the digitized echo data at the reduced peak-to-peak voltage; and communicating the configuration data at a second peak-to-peak voltage that is different than the reduced peak-to-peak voltage.

In some embodiments, the second peak-to-peak voltage is greater than the reduced peak-to-peak voltage.

In some embodiments, the method further comprises transmitting the digitized echo data and configuration data on a common wire of the cable assembly.

In some embodiments, the method further comprises communicating the digitized echo data from the transducer to the base system in a single-ended communication protocol.

In some embodiments, the method further comprises communicating the digitized echo data from the transducer to the base system in a DC coupled communication protocol.

In another aspect, a method of streaming digitized echo data between an ultrasound imaging transducer to a base system comprises: generating digitized echo data in response to configuration data at an ultrasound imaging transducer; generating the configuration data processing the digitized echo data to form an image at a base system; communicating the configuration data from the base system to the transducer in a first direction and that communicating the digitized echo data from the transducer to the base system in a second direction at a cable assembly; and transmitting the configuration data and the digitized echo data on a common channel of the cable assembly in a half-duplex configuration.

In some embodiments, the method further comprises transmitting the digitized echo data at a rate greater than about 1 Gbs from the transducer to the base system over the cable assembly at a reduced voltage at an electronic cable driver at the imaging transducer; and amplifying, at an amplifier at the base system, the received digitized echo data from the reduced voltage to an amplified voltage suitable for further processing at the base system to form the image, wherein the reduced voltage is about 300 mV peak to peak or less.

In some embodiments, the reduced voltage is about 200 mV peak to peak or less.

In some embodiments, the reduced voltage is about 150 mV peak to peak or less.

In some embodiments, the method further comprises communicating the digitized echo data at the reduced peak-to-peak voltage; and communicating the configuration data at a second peak-to-peak voltage that is different than the reduced peak-to-peak voltage.

In some embodiments, the second peak-to-peak voltage is greater than the reduced peak-to-peak voltage.

In some embodiments, the method further comprises transmitting the digitized echo data and configuration data on a common wire of the cable assembly.

In some embodiments, the method further comprises communicating the digitized echo data from the transducer to the base system in a single-ended communication protocol.

In some embodiments, the method further comprises communicating the digitized echo data from the transducer to the base system in a DC coupled communication protocol.

### BRIEF DESCRIPTION OF THE DRAWINGS

The representative embodiments are best understood from the following detailed description when read with the accompanying drawing figures. Wherever applicable and practical, like reference numerals refer to like elements.

FIG. 1A is a diagram of an ultrasound imaging system for imaging a portion of a body, using analog signal transmission between a transducer head and system according to current state of art.

FIG. 1B is a diagram of an ultrasound imaging system for imaging a portion of a body, using digital signal transmission between a transducer head and system using current state of art digital protocols.

FIG. 1C is a diagram of an ultrasound imaging system for imaging a portion of a body, using digital signal transmission between a transducer head and system according to a representative embodiment of the inventive concepts.

FIG. 2 is a schematic block diagram of an ultrasound imaging system for imaging a portion of a body, using digital signal transmission between a transducer head and system using current state of art protocols.

FIG. 3 is a schematic block diagram of an ultrasound imaging system for imaging a portion of a body, using differential digital signal transmission between a transducer head and system according to a representative embodiment of the inventive concepts.

FIG. 4 is a schematic block diagram of an ultrasound imaging system for imaging a portion of a body, using single ended digital signal transmission between a transducer head and system according to a representative embodiment of the inventive concepts.

FIG. 5A is a timing diagram of an ultrasound imaging system for imaging a portion of a body, using digital signal transmission between a transducer head and system using current state of art protocols.

FIG. 5B is a timing diagram of an ultrasound imaging system for imaging a portion of a body, using differential digital signal transmission between transducer head and system according to a representative embodiment of the inventive concepts.

FIG. 5C is a timing diagram of an ultrasound imaging system for imaging a portion of a body, using single-ended digital signal transmission between transducer head and system according to a representative embodiment of the inventive concepts.

FIG. 6A is a eye diagram of data transmission as seen by system field programmable array (FPGA) using current state of art protocols.

FIG. 6B is a eye diagram of differential data transmission as seen by system FPGA according to a representative embodiment of the inventive concepts.

FIG. 6C is a eye diagram of single ended data transmission as seen by system FPGA according to a representative embodiment of the inventive concepts.

### DETAILED DESCRIPTION

In the following detailed description, for the purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

The terminology used herein is for purposes of describing particular embodiments only and is not intended to be limiting. As used in the specification and appended claims, the singular forms of terms “a,” “an” and “the” are intended to include both singular and plural forms, unless the context clearly dictates otherwise. Additionally, the terms “comprises,” “comprising,” and/or similar terms specify the presence of stated features, elements, and/or components, but do not preclude the presence or addition of one or more other features, elements, components, and/or groups thereof. As used herein, the term “and/or” includes any and all combinations of one or more of the associated listed items.

As used in the specification and appended claims, and in addition to their ordinary meanings, the term ‘approximately’ means to with acceptable limits or degree. For example, “approximately 20 GHz” means one of ordinary skill in the art would consider the signal to be 20 GHz within reasonable measure.

The inventive concepts relate to high-speed serial data communication. Suitable tutorials on the current state of art and explanation of the technical terms used in this description may be found in “High-Speed Serial I/O Made Simple” by Abhijit Athavale and Carl Christensen published by Xilinx as well as “Interfacing Between LVPECL, VML, CML, and LVDS Levels” by Nick Holland published by Texas Instruments and “JESD204B Survival Guide” published by analog devices.

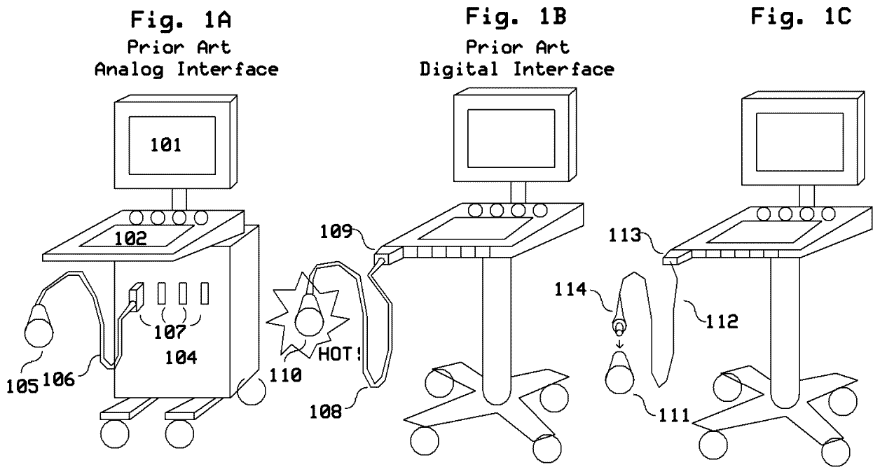

FIG. 1A is a diagram of an ultrasound (US) imaging system for imaging a portion of a body, using analog signal transmission between transducer head and system according to current state of art.

Transducer 105 consisting of acoustic elements transmits acoustic energy into the body in response to analog electrical signals sent from a base system over wires within a analog cable bundle 106. Acoustic echoes received from the body being imaged are converted to electrical signals by the acoustic elements and sent to the base system over the same cable bundle 106. The transducer may be a phased array, linear array, curved array or multi-dimensional matrix of elements housed in a handheld unit, endo-cavity form, catheter, transesophageal or any other type of transducer known for imaging.

The base system includes an electronic box 104 containing analog front end consisting of a number, typically 128 to 256, of analog to digital convertors. Data from the convertors is processed to form an image and displayed on display 101. A control panel 102 allows a user to control the system.

Multiple transducer connector ports 107, typically 4, allow multiple transducers to be plugged into the system with only one activated at a time using the control panel 102.

Electronic box 104 is typically large and costly, in the range of $1000 to $5000. The cable bundle 106 is large and stiff with 128 or more wires and is a significant cause of sonographer strain and failure due to wire fatigue. This cable bundle is also the costliest portion of the transducer assembly costing from $500 to $1500.

A method is needed to reduce the size and cost of the electronic box and cable assembly.

FIG. 1B is a diagram of an ultrasound imaging system for imaging a portion of a body, using digital signal transmission between transducer head and system using current state of art protocols as described in patent applications US20210007717A1 and W02023213748A1.

Using digital transmission allows the analog front end and analog to digital conversion to occur with the transducer head. This eliminates most of the electronics within the electronic box 104 allowing a smaller and lower cost system. Since data from multiple channels is streamed across each wire within the cable bundle 108, the number of wires within the bundle is reduced thereby increasing the reliability and lowering the cost. However, to minimize high frequency loss within cable bundle 108, each wire needs to be a higher diameter than the analog counterpart 106. Furthermore, each signal is sent as a differential signal doubling the wire count. These factors taken together prevent a significant reduction in the cable diameter.

Multiplexing data from multiple channels into each digital stream reduces the overall number of interconnects needed in the transducer connector 109 allowing smaller system connectors 109. However, the number of connections, typically 60 to over 100, is not reduced sufficiently to allow customer accessible connectors at the transducer head.

Moving the analog front end and analog to digital conversion to within the transducer head 110 increases the electrical power dissipation within the head resulting in excess heat in the head causing uncomfortable temperature when scanning. This heat limits the potential applications for this scheme. In particular, transesophageal and catheter imaging applications are a challenge since transducers for these application have a small thermal dissipation area. A significant portion of this electrical power is in the cable driving circuitry that drives the digital data into the cable assembly.

Inventive concepts provide for a small diameter cable with removable connector at the transducer head and relatively cool circuitry within the head while maintaining the cost savings of eliminating some circuitry in the system electronic box.

FIG. 1C is a diagram of an ultrasound imaging system for imaging a portion of a body, using digital signal transmission between transducer head and system according to a representative embodiment of the inventive concepts.

Through the use of novel low power cable drivers to transmit digital data from transducer head 111 to the base system, the transducer head 111 becomes cooler allowing transesophageal and catheter-based applications.

Using half duplex communication over the transducer bundle 112 and single ended transmission significantly reduces the cable diameter thereby reducing sonographer strain. Pin count in the connectors drops to range of 20 to 40 as compared to 60 to over 100 in the prior art. This reduction in pin countallows smaller system connectors 113 and the addition of a connector 114 at the transducer head. This connector at the head allows the customer to replace the cable should it fail due to wire fatigue, reducing down time and eliminating expensive service calls.

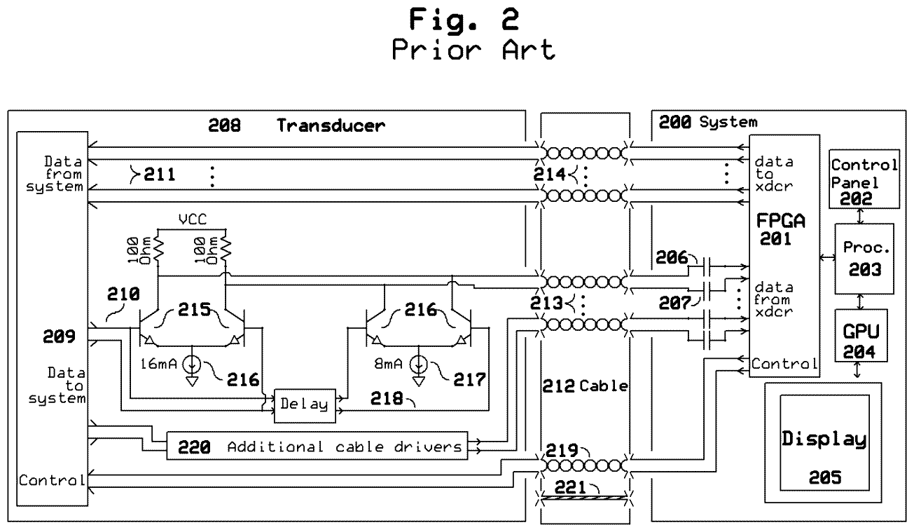

FIG. 2 is a schematic block diagram of an ultrasound imaging system for imaging a portion of a body, using digital signal transmission between transducer head and system using current state of art protocols. System 200 consists of a control panel 202, processor 203, optional graphics processor unit (GPU) 204, display 205 and a field programmable gate array (FPGA) 201 to transmit and receive digital data to and from the transducer.

Typically, the system also includes multiple connector ports and associated switching circuitry. These items have been eliminated from FIG. 2 for clarity. This omission is not meant to limit the scope of the inventive concepts. Both systems with and without multiple transducer connectors are within the scope of the inventive concepts.

Communication between the transducer and system occurs over a cable assembly 212. This cable assembly is typically in the range of 1 to 4 meters long depending on the clinical application.

Communication from the system to the transducer consists of data 211 to configure the transducer. Typically, from 1 to 32 or more pairs are used for this communication depending on the amount of data required. The amount of configuration data is small requiring low data rates in the range of 40 Mbs to 500 Mbs per differential pair. Low voltage differential signaling (LVDS) is typically used to send this data to the transducer.

A control signal 219 generated by the system FPGA indicates the interval where the transducer is configured by data sent from the system. This signal is also used to trigger the transmission of acoustic energy by the transducer.

Data from the transducer occurs at a much higher data rate in the range 1 Gbs to 8 Gbs per differential pair. This data is sent using the current mode logic (CML) protocol as used in the JESD204B standard as described in “JESD204B Survival Guide” published by analog devices.

Data bandwidths from the transducer to the system may exceed 100 Gbs which exceeds the approximately 5 Gbs per second capability of a single communication channel. A number N, from 1 to more than 32, of communication channels is needed to achieve the desired bandwidth. Data within a channel is sent over differential pairs 214 that can be formed by 2 individual coaxial cables, shielded twisted pair, unshielded twisted pair or twinax. N differential pairs and associated cable drivers 220 can be used to achieve the desired bandwidth. Cable driver circuitry 215-218 is shown for only one channel for clarity. Drive circuitry 220 uses similar differential circuitry as shown for the single channel.

Differential driver 215 biased at 16 mA with current source 216 drives the cable as specified in the CML standard. To compensate for high frequency loss in the cable assembly, logic transitions are accentuated using an additional differential drive 216 that is responsive to a delayed version 218 of the drive signal. Differential drive 216 is biased at 8 mA using current source 217. In this example, the total signal swing into the cable is 1.2 Vpp. Logic transitions produce a 1.2 Vpp swing whereas repeated logic levels produce 400 mVpp swing. This ratio is 9.5 dB which compensates for 9.5 dB of high frequency loss (at half the data rate) in the cable assembly.

Cable losses reduce the net signal seen at the system FPGA to 400 mVpp, the desired minimum signal level for reliable reception by the FPGA.

The cable bundle 212 typically also includes power, clock, control and ground wires 221. Any additional wires more than shown in the figure, does not limit the scope of the inventive concepts.

In a standard CML implementation, the signal path for receiving digitized echoes from the transducer is AC coupled using capacitors 206-207. While this allows the drive and receive electronics to have different quiescent points, it does require the signal to use an encoding scheme such as 8b10b encoding to maintain DC balance. The use of encoding reduces the transfer efficiency resulting in more thermal dissipation within the transducer head than otherwise needed.

The purpose of the optional GPU 204 is to provide any signal processing not performed within the FPGA or CPU. This may include beam formation, scan conversion, volume rendering, image enhancement, AI based algorithms or any other computationally intense processing.

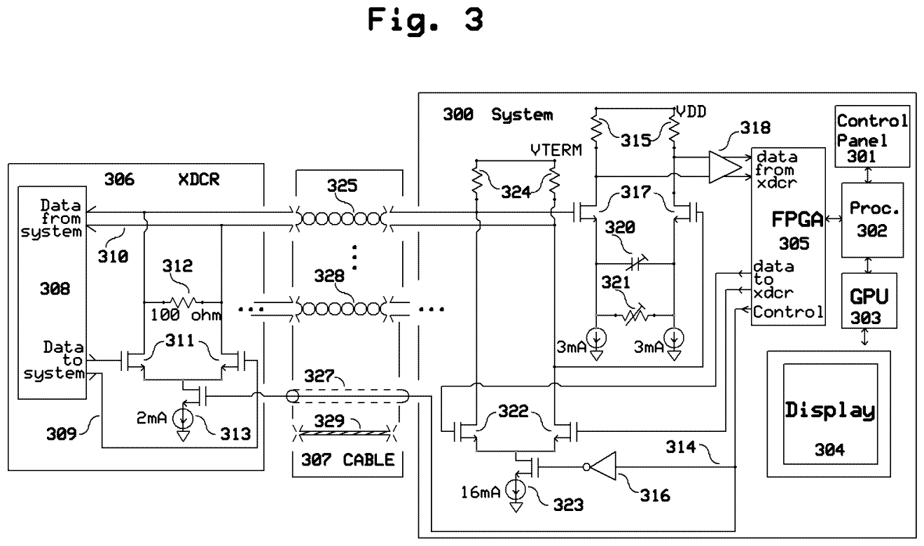

FIG. 3 is a schematic block diagram of an ultrasound imaging system for imaging a portion of a body, using differential digital signal transmission between transducer head and system according to a representative embodiment of the inventive concepts.

System 300 consists of a control panel 301, processor 302, optional graphics processor unit 303, display 304 and a field programmable gate array (FPGA) 305 to transmit and receive digital data to and from the transducer 306. These blocks serve the same function as in FIG. 2.

Typically, the system also includes multiple connector ports and associated switching circuitry. These items have been eliminated from FIG. 3 for clarity. This omission is not meant to limit the scope of the inventive concepts. Both systems with and without multiple transducer connectors are within the scope of the inventive concepts.

Communication circuitry for a transducer 306 is shown. Communication occurs over a cable assembly 307.

Core circuitry 308 within transducer 306 generates a stream of acoustic echo data 309 in response to configuration data 310 sent from the system.

To reduce wire count, it is recognized that configuration of the transducer with data communicated to the transducer occurs prior to communication of data from the transducer to the system. This allows for one pair of wires to be shared for both directions of communication in a half-duplex manner thereby reducing the wire count. Differential transistor pair 322 provides differential LVDS data to the transducer when gated on by the direction control signal 314 through invertor 316. Since the configuration data rate is small in the range of 40 Mbs to 500 Mbs per differential pair, cable loss is not significant, so no compensation is needed.

Data from the transducer occurs at a much higher data rate in the range 1 Gbs to 8 Gbs per differential pair. This data is sent using a novel protocol with a reduced drive and no compensation for cable loss on the drive end to reduce electrical power associated with compensation in the transducer head. Differential transistor pair 311 provides this drive using a reduced current 313 of 2 mA and a differential signal into the cable of 100 mVpp. While the state of art scheme using the CML standard with de-emphasis requires a total of 24 mA circuit current to drive the cable, this inventive scheme requires only 2 mA reducing the cable drive power by a factor of 12. Currents other than 2 mA and voltages other than 100 mVpp can be used and are considered within the scope of the inventive concepts. Such currents can range from 0.5 mA to 5 mA and voltage swings from 50 mVpp to 250 mVpp.

Since the FPGA 305 cannot handle the small 100 mVpp signal swing, and since there is no compensation for the cable loss at the drive end, circuitry within the system is needed to provide compensation and amplification ahead of the FPGA.

Differential amplifier 317 along with differential gain stage 318 provides the necessary amplification. Programmable capacitor 320 and resistor 321 provide the compensation (aka equalization) for the cable loss by selectively increasing the gain at high frequencies with the capacitor and flattening it at low frequencies with the resistor. Differential gain stage 318 provides a standard CML output to the FPGA of approximately 800 mVpp differential. Other methods of equalization such as with passive networks of resistors, capacitors, or inductors can be used and are considered within the scope of the inventive concepts.

A control signal 314 from the FPGA is used to set the direction of communication to and from the transducer. Since the signal levels used to communicate to the transducer (800 mVpp) is significantly different than that from the transducer (100 mVpp), a simple comparator looking for a change in common mode voltage of signal 310 can alternatively be used to generate the control signal for the transducer assembly eliminating the need for wire 327. This alternative is not shown in FIG. 3.

System circuitry 317,318,320-324 is preferably integrated into an integrated circuit.

Either Bipolar Junction transistors or Field effect transistors can be used for the differential amplifiers. Switches associated with multiple transducer ports (not shown) can also be integrated into the same integrated circuit device as the amplifiers saving space and cost.

Transducer circuitry 311-313 is preferably integrated into an integrated circuit. Either Bipolar Junction transistors or Field effect transistors can be used for the differential amplifiers.

A power saving feature is the implementation of the termination resistor 312 as a differential resistor that is not tied to the VDD power rail as in the CML implementation of FIG. 2. Another power reduction feature is the use of DC coupling throughout the signal path so that system termination voltage VTERM can be set to a low voltage reducing power dissipation within the transducer.

Another advantage of the use of DC coupling throughout the signal path is that it eliminates the need for encoding to maintain DC balance. This eliminates the overhead associated with encoding thereby further reducing the thermal dissipation within the transducer.

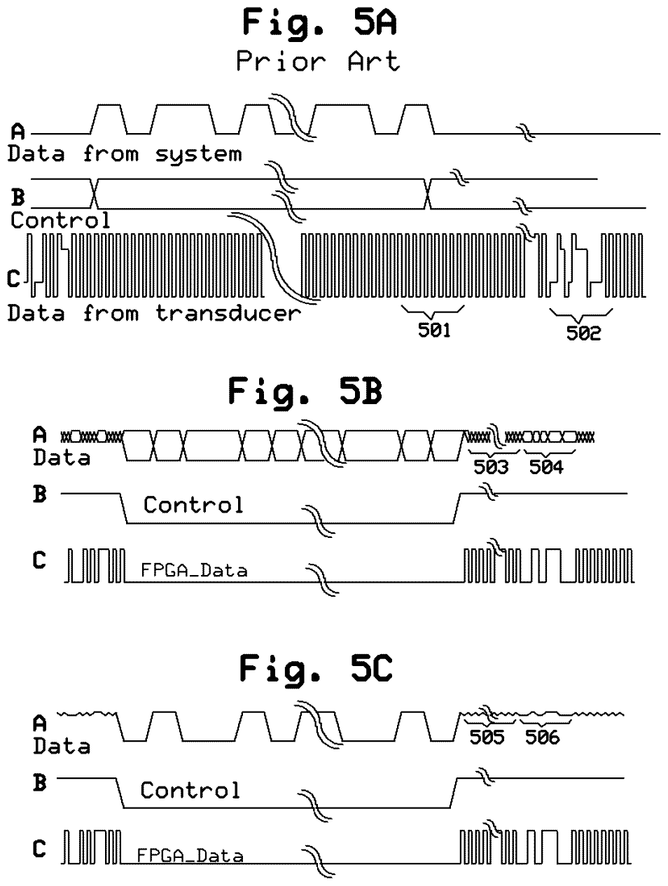

Half-Duplex operation prevents the continuous production of synchronous data edges into the FPGA high speed link circuitry making clock data recovery more challenging. To resolve this challenge, the links within the FPGA are reset during transducer configuration and a startup sequence is used to re-establish communication with the links after configuration and prior to transmission of data. This sequence occurs during the interval where the transducer is transmitting acoustic energy into the body and not yet receiving echoes. This will be discussed in detail when the timing diagrams (FIG. 5) are discussed.

Data bandwidths from the transducer to the system may exceed 100 Gbs which exceeds the approximately 5 Gbs per second capability of a single communication channel. A number N, from 1 to more than 32, of communication channels is desired to achieve the desired bandwidth. Data within a channel is sent over differential pairs 325,328 that can be formed by 2 individual coaxial cables, shielded twisted pair, unshielded twisted pair or twinax. N differential pairs are used to achieve the desired bandwidth. For clarity only the 1^{st} pair 325 and the Nth pair 328 are shown. Circuitry at the transducer 311-313 as well as at the system 316-324 is shown for only one channel for clarity. Channels 2 through N use similar but separate differential circuity as shown for the 1^{st} channel.

Typically, the cable bundle 307 also includes wires for power, ground and clock 329. Any additional wires not shown within the figure are considered within the scope of the inventive concepts.

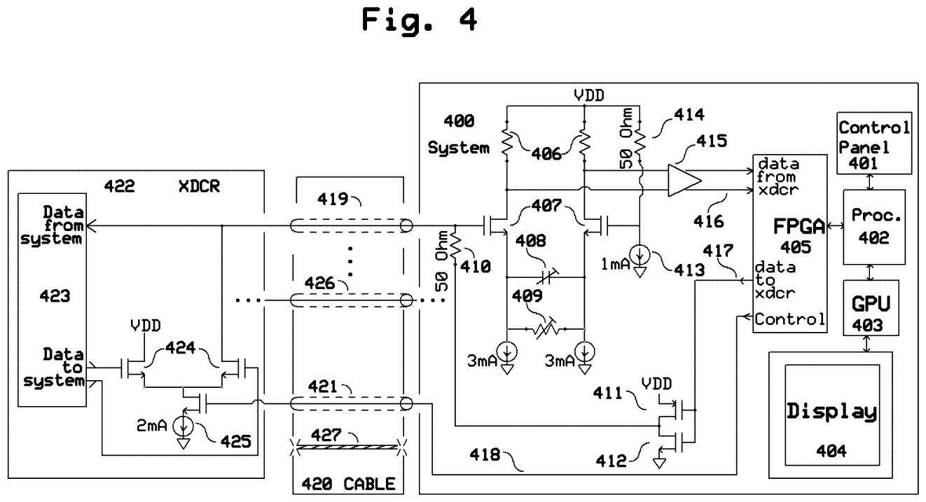

FIG. 4 is a schematic block diagram of an ultrasound imaging system for imaging a portion of a body, using single-ended digital signal transmission between transducer head and system according to another representative embodiment of the inventive concepts.

System 400 consists of a control panel 401, processor 402, optional graphics processor unit 403, display 404 and a field programmable gate array (FPGA) 405 to transmit and receive digital data to and from the transducer. These blocks serve the same function as in FIG. 2 and will not be described again.

Typically, the system also includes multiple connector ports and associated switching circuitry. These items have been eliminated from FIG. 4 for clarity. This omission is not meant to limit the scope of the inventive concepts. Both systems with and without multiple transducer connectors are within the scope of the inventive concepts.

Communication circuitry for transducer 422 is shown in more detail. Communication occurs over a cable assembly 420.

To reduce wire count, it is recognized that configuration of the transducer with data communicated to the probe occurs prior to communication of data from the transducer to the system. This allows for one wire to be shared for both directions of communication to and from the transducer in a half-duplex manner thereby reducing the wire count. Configuration of the transducer in this embodiment uses a low voltage complimentary metal oxide semiconductor (LVCMOS) driver formed by invertor FETs 411,412 to provide data to the transducer. Since this configuration data rate is small in the range of 40 Mbs to 500 Mbs per data stream, cable loss is not significant so no compensation is needed.

Data from the transducer occurs at a much higher data rate in the range 1 Gbs to 8 Gbs per data stream. This data is sent using a novel protocol with a reduced drive and no compensation for cable loss on the drive end to reduce electrical power associated with compensation in the transducer head. Differential transistor pair 424 provides this drive using a reduced current 425 of 2 mA. Only one output of the differential transistor pair is used to drive a single ended signal into the cable of 100 mVpp. While the state of art scheme with de-emphasis using the CML standard requires a total of 24 mA circuit current, this inventive scheme requires only 2 mA reducing the cable drive power by a factor of 12. Currents other than 2 mA and voltages other than 100 mVpp can be used and are considered within the scope of the inventive concepts. Such currents can range from 0.5 mA to 5 mA and voltage swings from 50 mVpp to 250 mVpp.

Since the FPGA 405 cannot handle the small 100 mVpp signal swing, and since there is no compensation for the cable loss at the drive end, circuitry within the system is needed to provide compensation and amplification ahead of the FPGA.

Differential amplifier 407 along with differential gain stage 415 provide the necessary amplification. Since the signal from the transducer is single ended, only one input of the differential amplifier is connected to the transducer. The other input is set to the signal mid-point by the current source 413 and resistor 414. Programmable capacitor 408 and resistor 409 provide compensation for the cable loss by selectively increasing the gain at high frequencies with the capacitor and flattening it at low frequencies with the resistor. Differential gain stage 415 provides a standard CML output to the FPGA of approximately 800 mVpp differential. Other methods of equalization such as with passive networks of resistors, capacitors, or inductors can be used and are considered within the scope of the inventive concepts.

System circuitry shown 406-415 is preferably integrated into an integrated circuit. Either Bipolar Junction transistors or Field effect transistors can be used for the differential amplifiers. Switches associated with multiple transducer ports (not shown) can also be integrated into the same integrated circuit device as the amplifiers saving space and cost.

Transducer circuitry 424,425 is preferably integrated into an integrated circuit. Either Bipolar Junction transistors or Field effect transistors can be used for the differential amplifiers.

Another power reduction feature is the use of DC coupling throughout the signal path so that system termination voltage VDD can be set to a low voltage reducing power dissipation within the transducer.

Another advantage of the use of DC coupling throughout the signal path is that it eliminates the need for encoding to maintain DC balance. This eliminates the overhead associated with encoding thereby further reducing the thermal dissipation within the transducer.

Half-Duplex operation prevents the continuous production of synchronous data edges into the FPGA high speed link circuitry making clock data recovery more challenging. To resolve this challenge, the links within the FPGA are reset during transducer configuration and a startup sequence is used to re-establish communication with the links after configuration and prior to transmission of data. This sequence occurs during the interval where the transducer is transmitting acoustic energy into the body and not yet receiving echoes. This will be discussed in detail when the timing diagrams of FIG. 5 are discussed.

Data bandwidths from the transducer to the system may exceed 100 Gbs which exceeds the approximately 5 Gbs per second capability of a single communication channel. A number N, from 1 to more than 32, of communication channels is desired to achieve the desired bandwidth. Data within a channel is sent over coaxial cable 419,426. N coaxial cables are used to achieve the desired bandwidth. For clarity only the 1^{st} cable 419 and the Nth cable 426 are shown. Circuitry at the transducer 424,425 as well as at the system 406-417 is shown for only one channel for clarity. Channels 2 through N use similar but separate differential circuity as shown for the 1^{st} channel.

Typically, the cable bundle 420 also includes wires for power, ground and clock 427. Any additional wires not shown within the figure are considered within scope of the inventive concepts.

In this single ended scheme, the total wire count (connector pin count) at the transducer end is sufficiently small to allow a customer accessible connector allowing replacement of the cable assembly in the field. The size of this connection may be similar to that of a USB-C connector.

FIG. 5A is a timing diagram of an ultrasound imaging system for imaging a portion of a body, using digital signal transmission between transducer head and system using current state of art protocols.

The transducer is configured using LVDS data (Waveform A) over a 1 us to 20 us interval depending on amount of data required.

A control line (Waveform B), also LVDS in this embodiment, but could be any other logic scheme, indicates the configuration interval and triggers the transmission of the acoustic energy into the patient. This control line also sets the output data from the probe to the system to an “idle” pattern 501 with many transitions to aid clock recovery by the FPGA serial links. This control line also resets the FPGA serial links to reset any previous fault condition. Sometime in the range 100 ns to 5 us after the serial link reset, the transducer sends a known alignment code 502 to align the deserialization within the FPGA serial link circuitry. This may be set to occur before, during, or shortly after the acoustic transmit event.

The CML signal (waveform C) representing data from the transducer to the system is in the range of 400 mVpp to 1200 mVpp with the stronger signal level for the data bits (aka symbols) corresponding to logic level transitions and the smaller signal level corresponding to data bits (symbols) with repeated logic levels. This increase in signal level for bit transitions is formed by the 215 and 216 differential transistor pairs of FIG. 2, known as either pre-emphasis or de-emphasis in the literature, is used to compensate for high frequency loss in the cable assembly.

FIG. 5B is a timing diagram of an US imaging system for imaging a portion of a body, using differential digital signal transmission between transducer head and system according to a representative embodiment.

Communication in both directions is shared over a differential pair (waveform A) operating half-duplex. During configuration, data is sent using LVDS data over a 1 us to 20 us interval depending on amount of data required. After configuration, data is sent from the transducer to the system using the novel low voltage current mode logic.

A control signal (waveform B) generated within the FPGA indicates the configuration interval and triggers the transmission of the acoustic energy into the patient. This control signal also sets the output data from the probe to the system to an “idle” pattern 503 with many transitions to aid clock recovery by the FPGA serial links. In this example, the idle pattern alternates between logic high and logic low, but could be any chosen pattern. This control signal also resets the FPGA serial links to reset any previous fault condition. After sometime in the range 100 ns to 5 us after the serial link reset thereby allowing time to recover from reset, the transducer sends a known alignment code 504 to align the deserialization within the FPGA serial link circuitry. This may be set to occur before, during, or shortly after the acoustic transmit event.

The control signal (waveform B) can use any logic scheme such as LVDS or LVCMOS. Alternatively, it can be generated using a comparator looking at the common mode voltage of waveform A as described in the description of FIG. 3.

In this embodiment, the data (waveform A) has two different logic levels. When transmitting data from the transducer to the system, the inventive low power level is used. In this case, it is generated with a 2 mA current in the output stage resulting in a 100 mVpp signal. Other currents in the range 0.5 mA to 5 mA could be used with logic levels from 50 mVpp to 250 mVpp. Configuration data from the system to the transducer is sent at a higher logic level. In this embodiment, 800 mVpp LVDS is used allowing data to be fed directly into LVDS receivers within the transducer. The inventive concepts are not constrained by the choice of LVDS. Other logic levels or schemes could be used.

Waveform C is the signal seen by the system FPGA in response to the interface circuitry of FIG. 3. This signal is approximately 800 mVpp of good quality for reliable data transmission.

Through the use of the low power 100 mVpp signal and the half-duplex mode, the power dissipation within the transducer is dramatically reduced and the pin connection count also reduced.

FIG. 5C is a timing diagram of an ultrasound imaging system for imaging a portion of a body, using single ended digital signal transmission between transducer head and system according to a representative embodiment of the inventive concepts.

Communication in both directions is shared over a single ended coax operating half-duplex. During configuration, data (waveform A) is sent using LVCMOS over a 1 us to 20 us interval depending on amount of data required.

A control signal generated within the FPGA (waveform B) indicates the configuration interval and triggers the transmission of the acoustic energy into the patient. This control line also sets the output data from the probe to the system to an “idle” pattern 505 with many transitions to aid clock recovery by the FPGA serial links. In this example, the idle pattern alternates between logic high and logic low, but could be any chosen pattern. This control line also resets the FPGA serial links to reset any previous fault condition. A time in the range 100 ns to 5 us after the FPGA reset, the transducer sends a known alignment code 506 to align the deserialization within the FPGA serial link circuitry. This may be set to occur before, during, or shortly after the acoustic transmit event.

The control signal can be sent using any logic scheme such as LVDS or LVCMOS.

In this embodiment, the data (waveform A) has two different logic levels. When transmitting data from the transducer to the system, the inventive low power level is used. In this case, it is generated with a 2 mA current in the output stage resulting in a 100 mVpp signal. Other currents in the range 0.5 mA to 5 mA could be used with logic levels from 50 mVpp to 250 mVpp. Configuration data from the system to the transducer is sent at a higher logic level. This embodiment uses 1.8V LVCMOS allowing data to be fed directly into the transducer. The inventive concepts are not constrained by the choice of LVCMOS. Other logic levels or schemes could be used.

Waveform C is the signal seen by the system FPGA in response to the interface circuitry of FIG. 4. This signal is 800 mVpp of good quality for reliable data transmission.

Through the use of the low power 100 mV signal, the half-duplex mode and single ended coax, the power dissipation within the transducer is dramatically reduced and the pin connection count also is reduced.

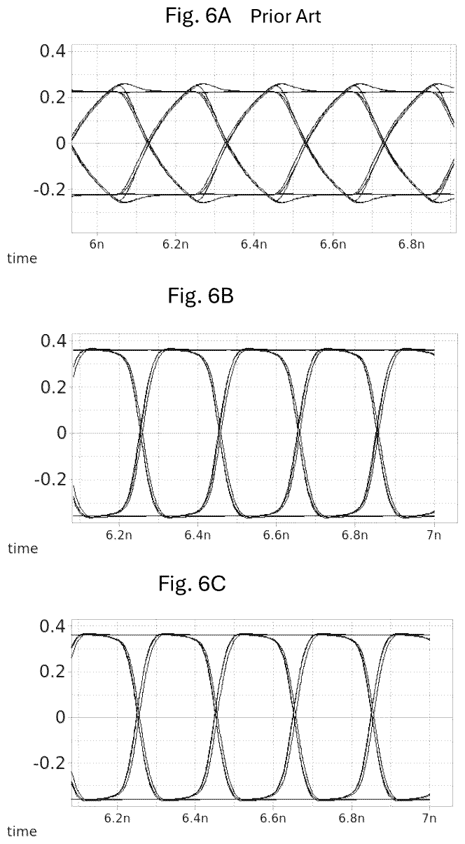

FIG. 6A is a eye diagram of data transmission at 5 Gbs (Giga bits per second) as seen by system FPGA using current state of art protocols. This eye diagram was produced through SPICE simulations of an actual design using the open source Skywater 130 nm integrated circuit process. Through the use of de-emphasis in the transducer and the CML standard a marginal, but acceptable eye diagram is produced of 400 mVpp after the cable loss. This is at the lower range of an acceptable signal level for reliable data recovery by most FPGAs. However, significant power and number of interconnections was required to produce this result.

FIG. 6B is a eye diagram of differential 5 Gbs data transmission as seen by system FPGA according to a representative embodiment of the inventive concepts. This eye diagram was produced through SPICE simulations of an actual design using the open source Skywater 130 nm integrated circuit process. The inventive scheme using amplification and equalization within the system produces a clean eye of 750 mVpp including the cable loss and should be reliably recovered by the FPGA high speed link. The output stage power level required for this is 12 times less than that required for that of FIG. 6A. The number of interconnects required is reduced through the use of half-duplex communication.

FIG. 6C is a eye diagram of single ended 5 Gbs data transmission as seen by system FPGA according to a representative embodiment. This eye diagram was produced through SPICE simulations of an actual design using the open source Skywater 130 nm integrated circuit process.

The inventive scheme using amplification and equalization within the system produces a clean eye of 750 mVpp including the cable loss and should be reliably recovered by the FPGA high speed link. The output stage power level required for this is 12 times less than that required for that of FIG. 6A. The number of interconnects required is further reduced through the use single ended communication links.

It should be appreciated that the various components described can be combined or used independently without limiting the scope of the inventive concepts. For example, one could choose to reduce the interconnects through the use of half duplex without using the low power data scheme. As another example, one could use the low power data transmission without the use of half-duplex mode. All such examples are considered within the scope of the inventive concepts.

As will be appreciated by one of ordinary skill in the art having the benefit of the present disclosure, devices, systems and methods of the present teachings, can provide the transmission of echo image data from an ultrasound device with low power consumption and with a reduced number of interconnects.

Although methods, systems and components for implementing imaging protocols have been described with reference to several exemplary embodiments, it is understood that the words that have been used are words of description and illustration, rather than words of limitation. Changes may be made within the purview of the appended claims, as presently stated and as amended, without departing from the scope and spirit of the implementation of the present teachings. The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. An ultrasound imaging system, comprising:
an ultrasound imaging transducer that produces digitized echo data in response to the transmission of acoustic energy;
a base system that processes the digitized echo data;
a cable assembly that communicates the digitized echo data between the transducer and the base system;
an electronic cable driver at the imaging transducer constructed and arranged to transmit the digitized echo data at a rate greater than about 1 Gbs from the transducer to the base system over the cable assembly at a reduced voltage; and
an amplifier at the base system to amplify received digitized echo data from the reduced voltage to an amplified voltage suitable for further processing at the base system,
wherein the reduced voltage is about 300 mV peak to peak or less.

2. The ultrasound imaging system of claim 1, wherein the reduced voltage is about 200 mV peak to peak or less.

3. The ultrasound imaging system of claim 1, wherein the reduced voltage is about 150 mV peak to peak or less.

4. The ultrasound imaging system of claim 1
wherein the cable assembly communicates the digitized echo data from the transducer to the base system in a first direction,
wherein the cable assembly communicates the configuration data from the base system to the transducer in a second direction, and
wherein the digitized echo data and configuration data are transmitted on a common channel of the cable assembly in a half-duplex configuration.

5. The ultrasound imaging system of claim 4 wherein the digitized echo data is communicated at the reduced peak-to-peak voltage, and wherein the configuration data is communicated at a second peak-to-peak voltage that is different than the reduced peak-to-peak voltage.

6. The ultrasound imaging system of claim 5 wherein the second peak-to-peak voltage is greater than the reduced peak-to-peak voltage.

7. The ultrasound imaging system of claim 4 wherein the digitized echo data and configuration data are transmitted on a common wire of the cable assembly.

8. The ultrasound imaging system of claim 1, wherein the digitized echo data is communicated from the transducer to the base system in a single-ended communication protocol.

9. The ultrasound imaging system of claim 1, wherein the digitized echo data is communicated from the transducer to the base system in a DC coupled communication protocol.

10. An ultrasound imaging system, comprising:
an ultrasound imaging transducer that produces digitized echo data in response to configuration data;
a base system that generates the configuration data and that processes the digitized echo data to form an image; and
a cable assembly that communicates the configuration data from the base system to the transducer in a first direction and that communicates the digitized echo data from the transducer to the base system in a second direction,
wherein the configuration data and the digitized echo data are transmitted on a common channel of the cable assembly in a half-duplex configuration.

11. The ultrasound imaging system of claim 10 further comprising:
an electronic cable driver at the imaging transducer constructed and arranged to transmit the digitized echo data at a rate greater than about 1 Gbs from the transducer to the base system in the first direction over the cable assembly at a reduced voltage; and
an amplifier at the base system to amplify received digitized echo data from the reduced voltage to an amplified voltage suitable for further processing at the base system to form the image,
wherein the reduced voltage is about 300 mV peak to peak or less.

12. The ultrasound imaging system of claim 11, wherein the reduced voltage is about 200 mV peak to peak or less.

13. The ultrasound imaging system of claim 11, wherein the reduced voltage is about 150 mV peak to peak or less.

14. The ultrasound imaging system of claim 10
wherein the digitized echo data is communicated at the reduced peak-to-peak voltage, and
wherein the configuration data is communicated at a second peak-to-peak voltage that is different than the reduced peak-to-peak voltage.

15. The ultrasound imaging system of claim 14 wherein the second peak-to-peak voltage is greater than the reduced peak-to-peak voltage.

16. The ultrasound imaging system of claim 10 wherein the digitized echo data and configuration data are transmitted on a common wire of the cable assembly.

17. The ultrasound imaging system of claim 10, wherein the digitized echo data is communicated from the transducer to the base system in a single-ended communication protocol.

18. The ultrasound imaging system of claim 10, wherein the digitized echo data is communicated from the transducer to the base system in a DC coupled communication protocol.

19-36. (canceled)
